(19) United States
(12) Patent Application Publication
(10) Pub. No.: US 2024/0326946 A1
(43) Pub. Date: Oct. 3, 2024

(54) ELECTRIC VEHICLE

(71) Applicant: HONDA MOTOR CO., LTD., Tokyo (JP)

(72) Inventor: Keisuke Nakata, Tokyo (JP)

(21) Appl. No.: 18/611,132

(22) Filed: Mar. 20, 2024

(30) Foreign Application Priority Data
Mar. 31, 2023 (JP) 2023-059261

(51) Int. Cl. B62K 11/04

(52) U.S. Cl. CPC B62K 11/04; B62K 2204/00

(57) ABSTRACT

In an electric vehicle provided with a vehicle body frame having a pivot frame that supports a swing arm swingably; a motor disposed above a pivot shaft; and a speed reduction gear disposed on a side of the motor, a lateral width of the pivot frame is narrower than a lateral width of the motor, and the speed reduction gear is disposed on a side of the pivot frame.

### INCORPORATION BY REFERENCE

The present application claims priority under 35 U.S.C. § 119 to Japanese Patent Application No. 2023-059261 filed on Mar. 31, 2023. The content of the application is incorporated herein by reference in its entirety.

### Technical Field

The present invention relates to an electric vehicle.

### Background Art

Conventionally, there has been known an electric vehicle where a motor is disposed above a pivot shaft, and a motor has a speed reduction mechanism. In the electric vehicle, power is transmitted by extending a chain that constitutes a power transmission member extending between a drive sprocket mounted on an output shaft of the speed reduction mechanism and a driven sprocket mounted on a drive wheel (see patent literature 1, for example). In patent literature 1, the speed reduction mechanism is disposed outside the motor in a width direction, and the motor and the speed reduction mechanism are disposed between pivot frames that support a swing arm.

### CITATION LIST

### Patent Literature

[Patent Literature 1] Japanese Patent No. 6977149

### SUMMARY OF INVENTION

### Technical Problem

In the technique described in patent literature 1, a size of a pivot frame in a vehicle width direction becomes lager than a size of a motor and a speed reduction mechanism. However, a swing arm is also disposed outside the pivot frame in the vehicle width direction and hence, there exists a task to make the size of the pivot frame in the vehicle width direction compact.

The present invention has been made in view of the above-mentioned circumstances, and it is an object of the present invention to provide an electric vehicle that includes a speed reduction gear on a side of the motor where the layout around a pivot shaft can be made compact.

### Solution to Problem

An electric vehicle is provided with: a vehicle body frame having a pivot frame that supports a swing arm swingably; a motor disposed above a pivot shaft; and a speed reduction gear disposed on a side of the motor. In the electric vehicle, a lateral width of the pivot frame is narrower than a lateral width of the motor, and the speed reduction gear is disposed on a side of the pivot frame.

### Advantageous Effects of Invention

It is possible to provide an electric vehicle where a layout around a pivot shaft can be made compact.

### BRIEF DESCRIPTION OF DRAWINGS

FIG. 1 is a left side view of an electric two-wheeled vehicle according to an embodiment of a present invention.

FIG. 2 is a right side view of the electric two-wheeled vehicle according to the embodiment of the present invention.

FIG. 3 is a front view of the electric two-wheeled vehicle according to the embodiment of the present invention.

FIG. 4 is a plan view of the electric two-wheeled vehicle according to the embodiment of the present invention.

FIG. 5 is a bottom plan view of the electric two-wheeled vehicle according to the embodiment of the present invention.

FIG. 6 is a left side view illustrating a main part of the electric two-wheeled vehicle in which the illustration of vehicle body cover is omitted.

FIG. 7 is a front view of a pivot frame.

FIG. 8 is a left side view of the pivot frame.

FIG. 9 is a rear view of the pivot frame.

FIG. 10 is a right side view of the pivot frame.

FIG. 11 is a cross-sectional view taken along a line XI-XI in FIG. 6.

FIG. 12 is a cross-sectional view taken along a line XII-XII in FIG. 6.

FIG. 13 is a perspective view illustrating a periphery of a lower portion of a battery case as viewed from a front left side.

FIG. 14 is a perspective view illustrating a main part of the electric two-wheeled vehicle as viewed from a right rear side in which the illustration of the vehicle body cover is omitted.

FIG. 15 is a rear view of the electric two-wheeled vehicle that uses a side stand.

### DESCRIPTION OF EMBODIMENTS

The following describes an embodiment of the present invention with reference to the drawings. Note that, in the description, descriptions on directions such as front and rear, right and left, and upper and lower are identical to directions with respect to a vehicle body insofar as descriptions are not particularly given. Reference sign FR illustrated in each drawing indicates a front side of the vehicle body, reference sign UP indicates an upper side of the vehicle body, and reference sign LH indicates a left side of the vehicle body.

### Embodiment

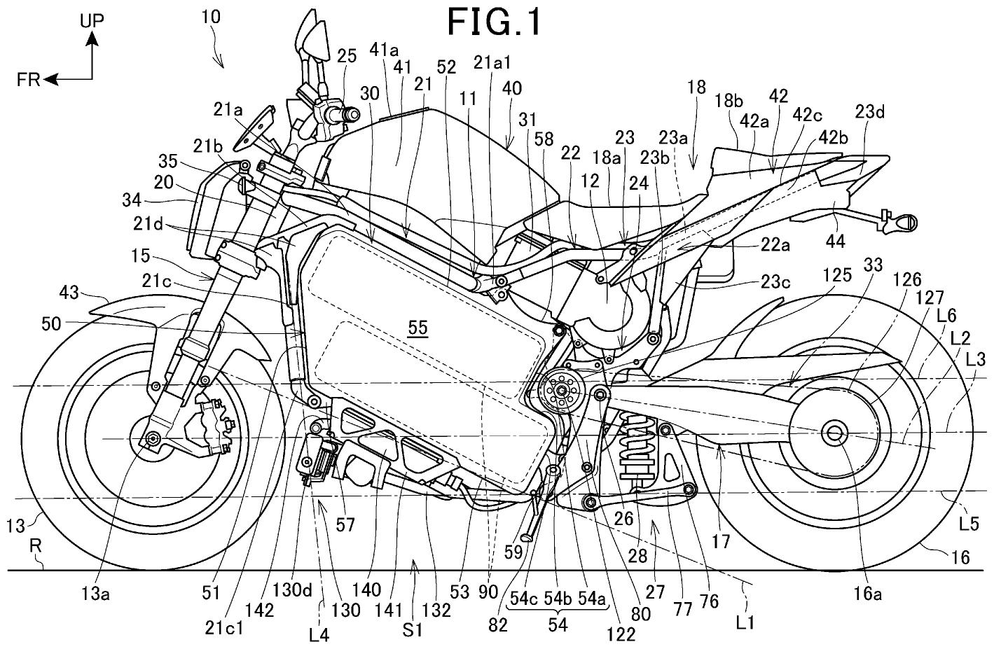

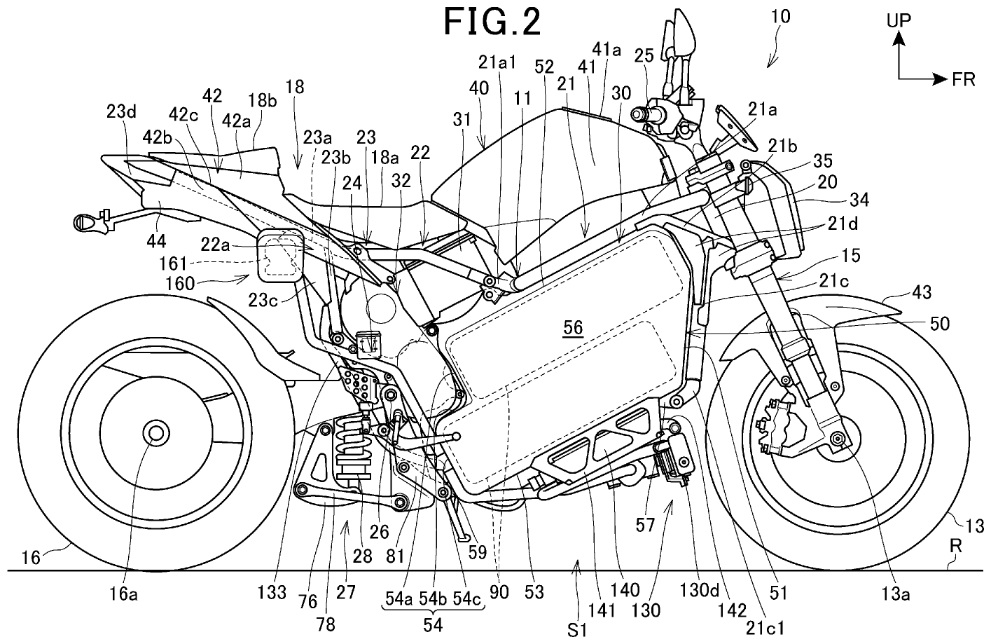

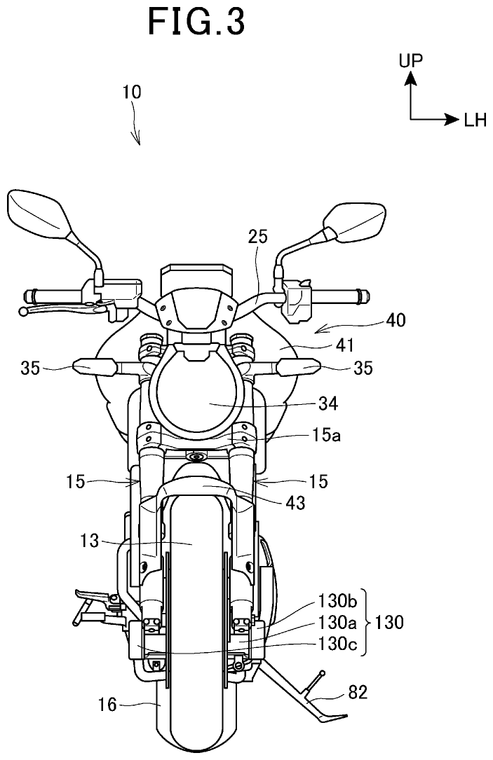

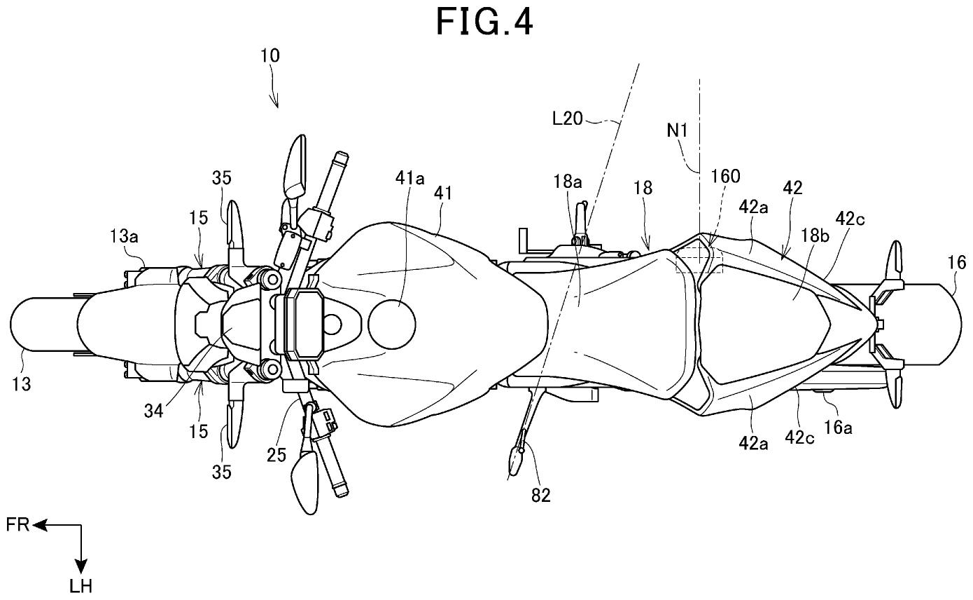

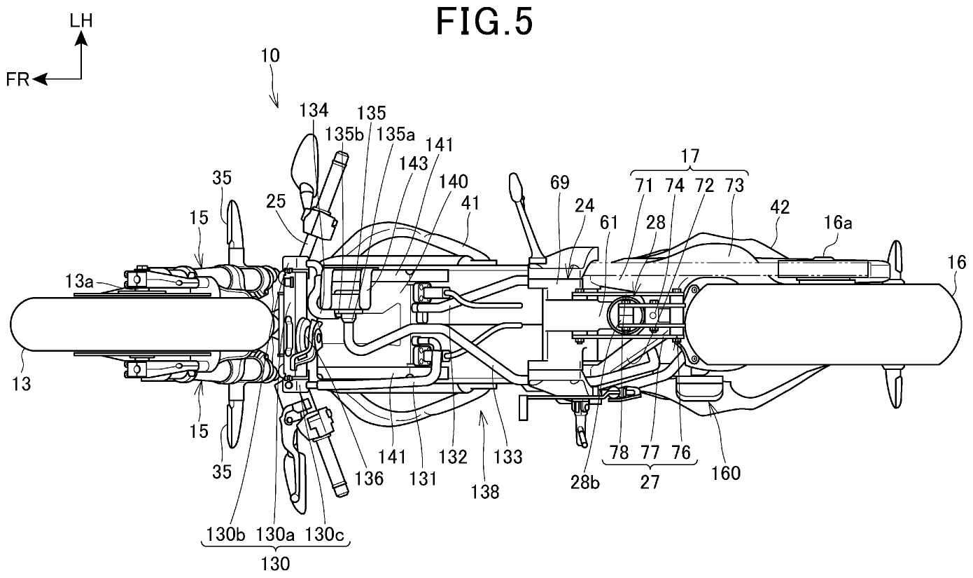

FIG. 1 is a left side view of an electric two-wheeled vehicle 10 according to an embodiment of a present invention. FIG. 2 is a right side view of the electric two-wheeled vehicle 10 according to the embodiment of the present invention. FIG. 3 is a front view of the electric two-wheeled vehicle 10 according to the embodiment of the present invention. FIG. 4 is a plan view of the electric two-wheeled vehicle 10 according to the embodiment of the present invention. FIG. 5 is a bottom plan view of the electric two-wheeled vehicle 10 according to the embodiment of the present invention.

The electric two-wheeled vehicle 10 (electric vehicle) 10 is a saddle riding vehicle where an electric motor (motor) 12 of a battery drive type is supported by a vehicle body frame 11, a front fork 15 that supports a front wheel 13 is steerably supported by a front end of the vehicle body frame 11, a swing arm 17 that supports a rear wheel 16 is swingably supported by a rear portion of the vehicle body frame 11, and a seat 18 on which an occupant is seated in a straddling manner is supported above a rear portion of the vehicle body frame 11.

The vehicle body frame 11 includes a head pipe 20 that is mounted on a front end portion, a front frame 21 that is positioned behind the head pipe 20, and a rear frame 22 that is positioned behind the front frame 21.

The front fork 15 is steerably mounted on the head pipe 20. A steering handlebar 25 is mounted on an upper portion of the front fork 15. A front wheel 13 is supported on a lower end portion of the front fork 15 by way of a front wheel shaft (axis) 13a.

The swing arm 17 is supported on a pivot shaft 26 that is supported on the rear frame 22. The pivot shaft 26 is a shaft that extends horizontally in a vehicle width direction. The swing arm 17 swings vertically about the pivot shaft 26. A rear cushion 28 is connected to the swing arm 17 by way of a link mechanism 27. The rear wheel 16 is supported on a rear end portion of the swing arm 17 by way of a rear wheel shaft (axis) 16a.

The seat 18 is disposed above the rear frame 22. The seat 18 is supported on the rear frame 22. The seat 18 includes a rider seat 18a on a front side and a passenger seat 18b that is disposed behind the rider seat 18a and above the rider seat 18a.

A battery 30 is supported on the front frame 21. A power control unit (PCU) 31 is disposed above the battery 30. The PCU 31 is configured to include an inverter and the like, for example, converts a direct current electricity supplied from the battery 30 to an alternative current electricity, and supplies the alternative current electricity after conversion to the electric motor 12. Further, the PCU 31, at the time of regenerating the electric motor 12, converts alternative current electricity that the electric motor 12 generates into the direct current electricity, and charges the battery 30 with electricity. The PCU 31 controls the electric motor 12 in response to a manipulation of the electric two-wheeled vehicle 10.

The electric motor 12 is disposed behind the PCU 31. The electric motor 12 is disposed above the pivot shaft 26. A speed reduction gear 32 (see FIG. 2) is disposed on a side of the electric motor 12. The electric motor 12 transmits a drive force to the power transmission mechanism 33 (see FIG. 1) by way of the speed reduction gear 32. The power transmission mechanism 33 transmits a drive force from the electric motor 12 to the rear wheel 16.

A headlight 34 is supported on the front fork 15. A pair of left and right front blinkers 35 is supported on a rear upper portion of the headlight 34.

The vehicle body frame 11 includes a vehicle body cover 40.

The vehicle body cover 40 of this embodiment includes: a unit cowl 41 that is disposed above the front frame 21; and a rear cowl 42 that is supported on the rear frame 22.

The unit cowl 41 is a bowl-shaped cover that is recessed downward. The unit cowl 41 has an external appearance shape that stimulates a fuel tank of the saddle riding vehicle having an internal combustion engine. The unit cowl 41 is disposed between the steering handlebar 25 and the seat 18. The unit cowl 41 covers a front portion of the electric two-wheeled vehicle 10 from above. A lock mechanism 41a is disposed on an upper surface of the unit cowl 41. The unit cowl 41 is detachably mounted on a vehicle body by a manipulation of the lock mechanism 41a.

The rear cowl 42 is disposed between the seat 18 and the rear wheel 16. The rear cowl 42 covers a lower side of the seat 18 from a side of the vehicle body. The rear cowl 42 includes: upper surfaces (first surfaces) 42a that extend from the lower side of the seat 18 toward the outside in the vehicle width direction. Lower surfaces (second surfaces) 42b that extend toward the inside in the vehicle width direction as the lower surfaces 42b extend downward are formed on outer ends of the upper surfaces 42a in a vehicle width direction. A connecting portion between the upper surface 42a and the lower surface 42b is formed in a shape protruding toward the outside in the vehicle width direction, and forms a ridge 42c of the rear cowl 42.

A front fender 43 that covers the front wheel 13 from above is mounted on the front fork 15. A rear fender 44 that covers the rear wheel 16 from above is mounted on the rear frame 22.

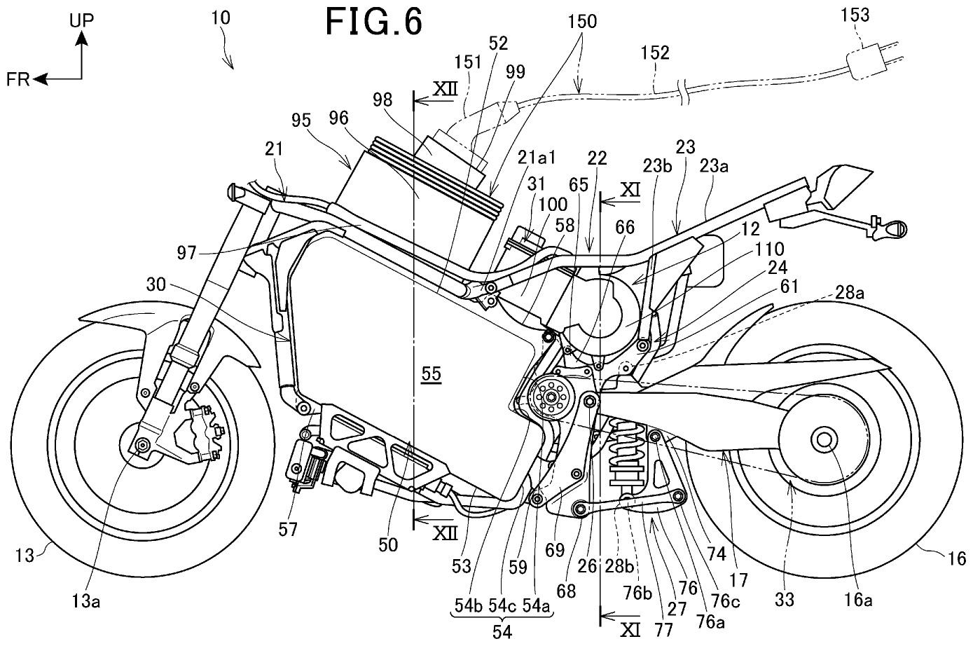

FIG. 6 is a left side view illustrating a main part of the electric two-wheeled vehicle 10 in a state where the vehicle body cover 40 is omitted. As illustrated in FIG. 1 to FIG. 6, in the vehicle body frame 11 according to the present embodiment, the front frame 21 and the rear frame 22 are formed as separate bodies from each other. That is, the front frame 21 and the rear frame 22 are configured to be dividable in the longitudinal direction.

Further, the rear frame 22 according to the present embodiment includes a seat frame 23 on an upper side and a pivot frame 24 on a lower side. In the rear frame 22 according to the present embodiment, the seat frame 23 and the pivot frame 24 are formed as separate bodies from each other. That is, the seat frame 23 and the pivot frame 24 are configured to be dividable vertically.

The front frame 21 extends rearward from the head pipe 20.

The front frame 21 includes a pair of left and right upper frames (main frames) 21a that extends rearward and downward from an upper end portion of the head pipe 20. Front end portions of the upper frames 21a extend toward the outside in the vehicle width direction as the upper frames 21a advance rearward, and at portions behind the front end portions, the upper frames 21a extend in a straight-line shape rearward and downward. A connecting portion 21a1 is formed on a rear end portion of the upper frame 21a.

To lower portions of the front end portions of the upper frame 21a, a pair of left and right sub frames 21b that extends rearward and upward from a lower end portion of the head pipe 20 is connected. Rear end portions of the sub frames 21b are connected to the respectively corresponding upper frames 21a.

To lower portions of the front end portions of the sub frames 21b, a pair left and right down frames 21c that extends downward from the head pipe 20 is connected. The down frames 21c are connect to a lower end portion of the head pipe 20 by way of the sub frames 21b. The down frames 21c, as viewed in a side view of the vehicle, extend rearward and downward in a straight-line shape. As viewed in a side view of the vehicle, the down frames 21c extend downward at a steeper inclination than the upper frames 21a. Battery support portions 21c1 are formed on lower end portions of the down frames 21c.

A connecting portion between the sub frame 21b and the down frame 21c is reinforced by a gusset 21d.

The front frame 21 according to the present embodiment is constituted of the upper frames 21a, the sub frames 21b, the down frames 21c and the gussets 21d. In the front frame 21, the upper frames 21a, the sub frames 21b and the down frames 21c are formed in a pipe shape.

The rear frame 22 is connected to the connecting portion 21a1 of the rear end portion of the upper frame 21a. More specifically, the seat frame 23 of the rear frame 22 is connected to the connecting portion 21a1. The seat frame 23 is fastened to the connecting portion 21a1 of the upper frame 21a by a fastening member. The fastening member is a bolt, for example.

The seat frame 23 includes a pair of left and right seat rails 23a that extends rearward and upward. The seat rails 23a extend rearward and upward from the pair of respective left and right upper frames 21a. The seat rails 23a extend to a rear end portion of the vehicle body. The seat 18 is supported above the seat rails 23a. The seat rails 23a are covered by the rear cowl 42 from the left and right sides.

Seat sub frames 23b that extend downward are connected to intermediate portion of the pair of left and right seat rails 23a in the longitudinal direction respectively. The seat sub frames 23b extend frontward and downward at inclination steeper than inclination of the seat rails 23a, and are connected to the pivot frame 24 that forms a frame different from the seat rails 23a. In other words, the seat sub frames 23b extend rearward and upward from the pivot frame 24, and support the seat rails 23a.

Connecting portions 22a between the pivot frame 24 and the seat sub frames 23b are reinforced by rear gussets 23c. The rear gusset 23c is a plate member having an approximately triangular shape as viewed in a side view of the vehicle. The rear gussets 23c are arranged along a rear sides of upper end portions of the seat sub frames 23b and along lower portions of the seat rails 23a, and are welded so as to cover upper end portions of the seat sub frames 23b and lower portions of the seat rails 23a from sides of the vehicle. Behind the connecting portions 22a, grab rails 23d are mounted on the seat rails 23a. Due to such a configuration, the seat frames 23 that support the seat 18 are disposed in a straddling manner in the longitudinal direction between the upper frames 21a and the pivot frames 24.

The seat frame 23 of this embodiment is constituted of the seat rails 23a, the seat sub frames 23b, the rear gussets 23c, and the grab rails 23d. In the seat frame 23, the seat rails 23a and the seat sub frames 23b are formed in a pipe shape.

A battery case 50 that is an exterior member of the battery 30 is supported by the front frames 21 and the pivot frames 24. The battery case 50 has a hollow box shape. As viewed in a side view of the vehicle, the battery case 50 is disposed such that the battery case 50 is surrounded by the front frames 21 and the pivot frames 24.

To be more specific, as viewed in a side view of the vehicle, the battery case 50 includes: a front surface portion 51 that extends along the sub frames 21b and the down frames 21c of the front frame 21; a ceiling surface portion 52 that extends rearward from an upper end of the front surface portion 51 along the upper frames 21a; a bottom surface portion (a bottom surface of the battery) 53 that extends from a lower end of the front surface portion 51 along an inclined shape of the ceiling surface portion 52; a rear surface portion 54 that connects a rear end of the ceiling surface portion 52 and a rear end of the bottom surface portion 53 to each other; a side surface portion 55 on a left side (see FIG. 1) that is disposed on a left side of the front surface portion 51, ceiling surface portion 52, the bottom surface portion 53 and the rear surface portion 54; and a side surface portion 56 on a right side (see FIG. 2) that is disposed on a right side of the front surface portion 51, the ceiling surface portion 52, the bottom surface portion 53 and the rear surface portion 54.

The rear surface portion 54 has a stepped shape as viewed in the side view of the vehicle. More specifically, the rear surface portion 54 includes: a front side rear surface 54a that extends from a rear end of the ceiling surface portion 52 toward a lower side; a stepped surface 54b that extends from a rear end of the front side rear surface 54a toward a rear side; and a rear side rear surface 54c that extends from a rear end of the stepped surface 54b toward a lower side.

In the battery case 50, on a front end of the bottom surface portion 53, a front end fixing portion 57 that protrudes frontward and downward is formed. The front end fixing portion 57 is disposed between the battery support portions 21c1 of the left and right down frame 21c. A fixing member is made to pass through the battery support portion 21c1 in the vehicle width direction. With such a configuration, the front end fixing portion 57 is fixed to the battery support portion 21c1.

An upper end fixing portion 58 (see FIG. 6) that protrudes upward is formed on a rear end portion of the ceiling surface portion 52. As illustrated in FIG. 6, the upper end fixing portion 58 extends in the longitudinal direction. The upper end fixing portion 58 is formed on a center portion in the vehicle width direction. The upper end fixing portion 58 is fixed to the connecting portion 21a1 of the upper frame 21a at a front end side thereof. A rear end side of the upper end fixing portion 58 protrudes rearward from the front side rear surface 54a of the battery case 50. The upper end fixing portion 58 is fixed to an upper portion of the pivot frame 24 on a rear end side thereof.

A rear end fixing portion 59 that protrudes rearward is formed on the rear side rear surface 54c. The rear end fixing portion 59 is fixed to a lower portion of the pivot frame 24.

A lower end of the pivot frame 24 is positioned below the battery support portions 21c1 of the down frames 21c. The battery case 50 is supported by the down frames 21c and the pivot frames 24, and the battery case 50 of the battery 30 is disposed in an extending manner between the down frame 21c and the pivot frames 24. That is, the battery 30 is disposed such that a rear side of the bottom surface portion 53 is lower than a front side of the bottom surface portion 53. As viewed in a side view of the vehicle, the bottom surface portion 53 extends along a line L1 (see FIG. 1) that connects a lower end of the down frame 21c and a lower end of the pivot frame 24. An inclination angle that the bottom surface portion 53 makes with respect to a road surface (ground) R is set to an acute angle. Below the bottom surface portion 53, a space S1 having an approximately triangular shape as viewed in a side view of the vehicle that is formed by the front wheel 13, the road surface R and the bottom surface portion 53 is formed.

In this embodiment, the vehicle body of the electric two-wheeled vehicle 10 having the skeletal frame structure is formed of: the vehicle body frame 11 constituted of the pivot frame 24 of the front frame 21 and the rear frame 22; the battery case 50 that houses the battery 30; and the like.

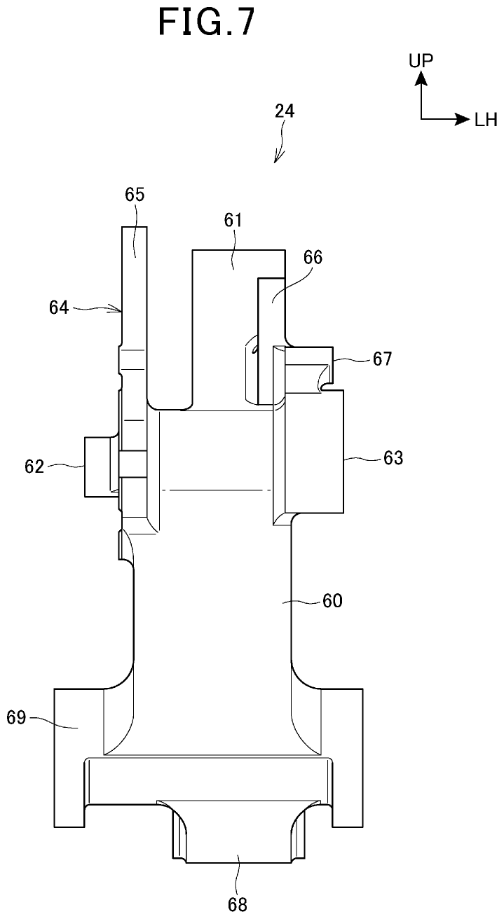

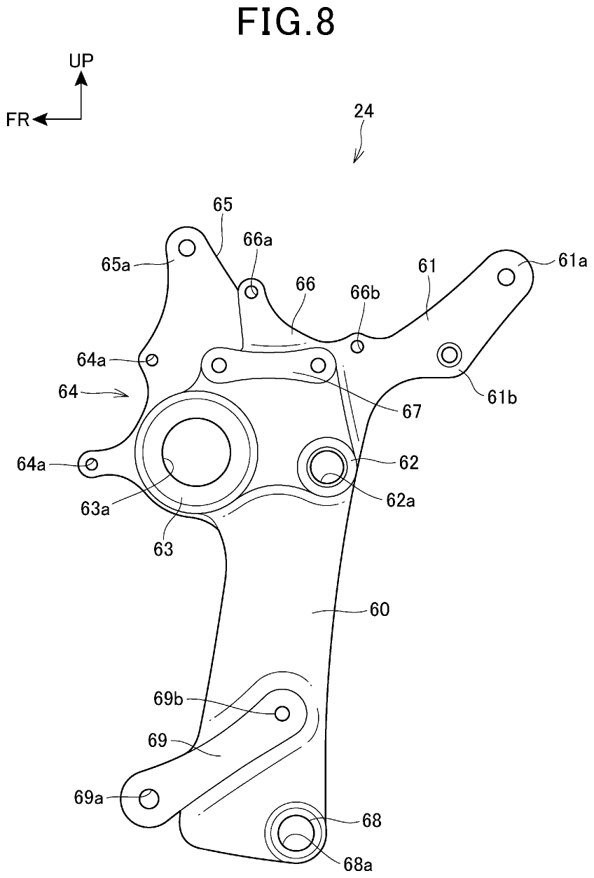

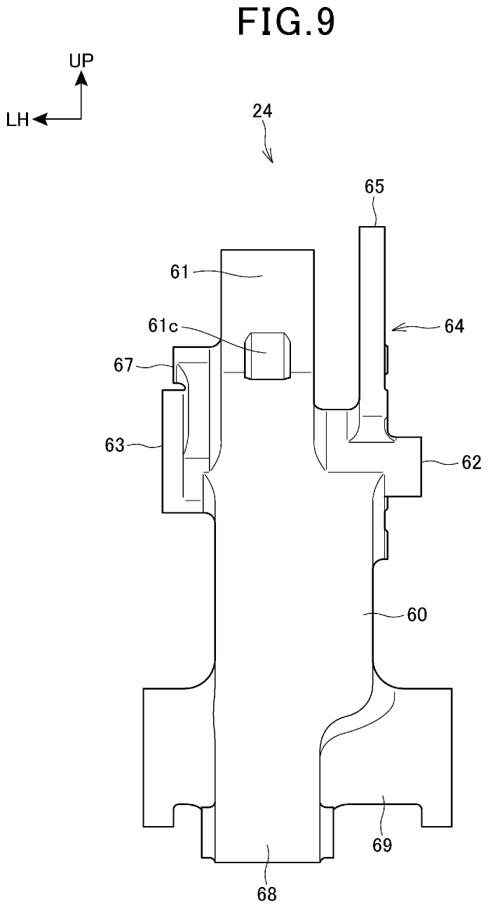

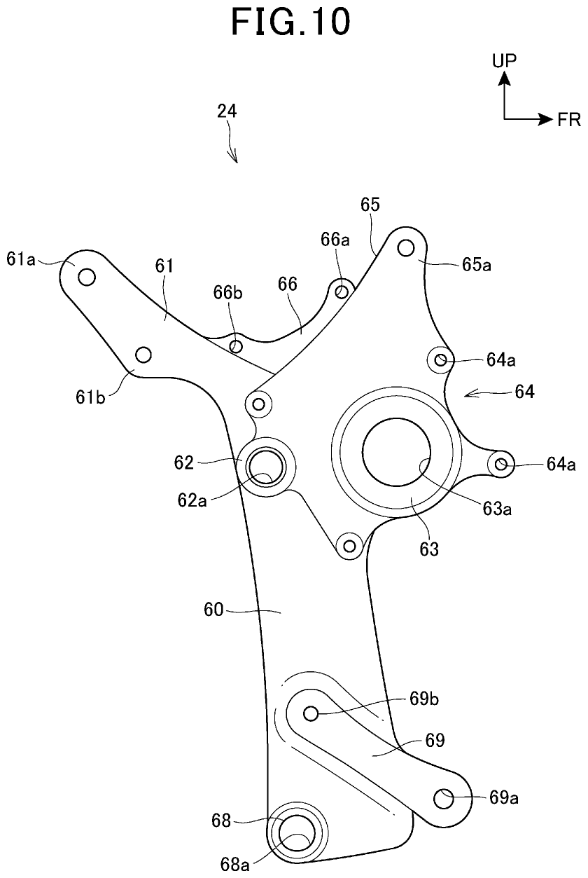

FIG. 7 is a front view of the pivot frame 24. FIG. 8 is a left side view of the pivot frame 24. FIG. 9 is a rear view of the pivot frame 24. FIG. 10 is a right side view of the pivot frame 24.

The pivot frame 24 according to this embodiment is an integrally formed single frame having the solid structure. The pivot frame 24 is a cast product, for example. The pivot frame 24 is solid and hence, the pivot frame 24 can ensure rigidity and a strength.

The pivot frame 24 according to this embodiment has a columnar portion 60 having an approximately quadrangular columnar shape that extends in the vertical direction. To be more specific, the columnar portion 60 is slightly inclined rearward as the columnar portion 60 advances upward. A rear arm portion (second arm) 61 that extends rearward and upward is formed on an upper side of the columnar portion 60. The rear arm portion 61 extends rearward along an outer periphery of the electric motor 12 (see FIG. 6). A frame fixing portion 61a in which a through hole that penetrates in the vehicle width direction (left and right direction) is formed on a distal end portion (a rear end portion) of the rear arm portion 61. A cushion connecting portion 61b in which a through hole that penetrates in the vehicle width direction is formed in a front lower portion of the frame fixing portion 61a. A cushion insertion portion 61c that is recessed upward is formed in a rear lower surface of the rear arm portion 61 corresponding to the cushion connecting portion 61b (see FIG. 9). The cushion connecting portion 61b and the cushion insertion portion 61c are formed at an intermediate portion of the rear arm portion 61 in the longitudinal direction.

Between the columnar portion 60 and the rear arm portion 61, a pivot shaft support portion 62 having a cylindrical shape that extends in the vehicle width direction is formed corresponding to a connecting portion between the columnar portion 60 and the rear arm portion 61. The pivot shaft support portion 62 protrudes toward a right side (the other side in the lateral direction) from the columnar portion 60 (see FIG. 9). A pivot shaft hole 62a that penetrates in the vehicle width direction is formed in the pivot shaft support portion 62.

An output shaft support portion 63 having a cylindrical shape is formed on a front side of the pivot shaft support portion 62. The output shaft support portion 63 protrudes toward a left side (one side in the lateral direction) from the columnar portion 60 (see FIG. 9). An output shaft hole 63a that penetrates in the vehicle width direction is formed in the output shaft support portion 63. The output shaft hole 63a has a larger diameter than the pivot shaft hole 62a.

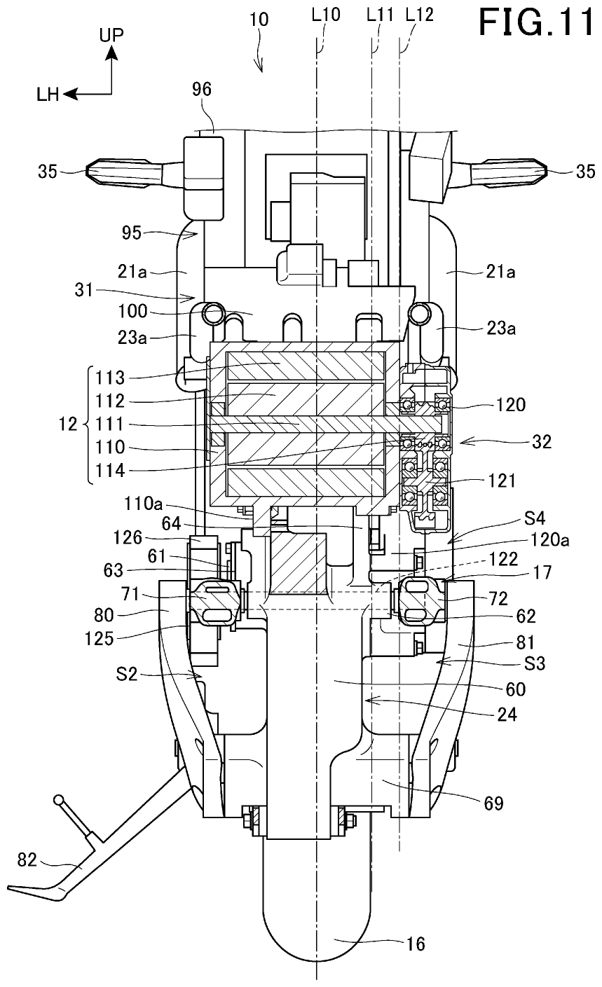

A fastening plate 64 having a plate shape is formed around the output shaft support portion 63. A plurality of fastening holes 64a are formed in an outer peripheral portion of the fastening plate 64. The fastening plate 64 is spaced apart from the rear arm portion 61 in the vehicle width direction (see FIGS. 7 and 9). The fastening plate 64 is formed in an offset manner toward a right side from the columnar portion 60 (see FIGS. 7 and 9). The fastening plate 64 is formed in an offset manner toward a right side from a vehicle width center line L10 (see FIG. 11). The fastening plate 64 has a smaller lateral width than the rear arm portion 61. The fastening plate 64 has a front arm portion (first arm) 65 that extends frontward along an outer periphery of the electric motor 12 (see FIG. 6). An upper edge of the front arm portion 65 is bent in a downwardly recessed manner along an outer periphery of the electric motor 12. A battery fixing portion 65a is formed in a distal end (a front end) of the front arm portion 65 by forming a through hole that penetrates in the vehicle width direction.

A motor fixing lug 66 that protrudes upward is formed between the rear arm portion 61 and the front arm portion 65 (see FIG. 10). A plurality of fastening portions 66a, 66b that penetrate in the vehicle width direction are formed in the motor fixing lug 66. Below the motor fixing lug 66, a seat portion 67 that protrudes toward a left side is formed (see FIG. 8). The seat portion 67 extends in the longitudinal direction.

A link connecting portion 68 having a cylindrical shape is formed on a rear portion of a lower end of the columnar portion 60. A link shaft hole 68a that penetrates in the vehicle width direction is formed in the link connecting portion 68.

Plate fixing portions 69 having a plate shape that extend in the vehicle width direction are formed on a front upper side of the link connecting portion 68. The plate fixing portions 69 protrude from both outer sides of the columnar portion 60 in the vehicle width direction (see FIG. 7 and FIG. 9). The plate fixing portions 69 protrude toward outside in the vehicle width direction from the pivot shaft support portion 62 and the output shaft support portion 63. The plate fixing portions 69 are gradually inclined downward as the plate fixing portions 69 advance frontward. Front ends of the plate fixing portions 69 protrude frontward from the columnar portion 60. A battery fixing hole 69a that penetrates in the vehicle width direction is formed on front end portions of the plate fixing portions 69 respectively. A plate fastening hole 69b that is recessed in the vehicle width direction is formed on rear end portions of the plate fixing portion 69 respectively.

In FIG. 6, the pivot frame 24 is connected to the front frames 21, the seat sub frames 23b of the rear frames 22, the electric motor 12 and the battery 30.

That is, in the pivot frames 24, at the front arm portions 65 and the rear arm portions 61 disposed along an outer periphery of the electric motor 12, to the battery fixing portion 65a of the front arm portions 65 (see FIG. 8), upper end fixing portions 58 of the battery case 50 and the electric motor 12 are fastened. Further, to the frame fixing portions 61a of the rear arm portions 61 (see FIG. 8), lower ends of the seat sub frames 23b are connected.

Further, at the pivot frames 24, the electric motor 12 and the like are fixed to the fastening plates 64 (see FIG. 8) and the motor fixing lugs 66 (see FIG. 8).

Further, at the pivot frame 24, the rear end fixing portion 59 of the battery case 50 is disposed between the left and right plate fixing portions 69, and the battery case 50 is fixed to the left and right plate fixing portions 69.

With such a configuration, the pivot frame 24 forms an integral shape together with the front frames 21, the rear frames 22 and the battery case 50. Since the pivot frames 24 form an integral shape with the battery case 50, the rigidity of the pivot frames 24 each having a narrow width can be enhanced.

With reference to FIG. 1 to FIG. 5, the pivot shaft 26 is supported by the pivot shaft support portion 62 of the pivot frame 24. The pivot shaft 26 penetrates the pivot shaft hole 62a (see FIG. 8), and protrudes toward both left and right sides of the pivot frame 24. The swing arm 17 is swingably supported by both end portions of the pivot shaft 26.

As illustrated in FIG. 5, the swing arm 17 has a pair of left and right pivot portions 71, 72 that extends in the longitudinal direction. The pivot portions 71, 72 are respectively disposed on both sides of the pivot frame 24 in the vehicle width direction. The pivot portions 71, 72 are swingably supported by way of the pivot shaft 26.

The pivot portion 71, 72 extend rearward from the pivot shaft 26. In such a configuration, the pivot portion 72 on the right side extends rearward from the pivot shaft 26, and is inclined toward a left side as the pivot shaft 26 advances rearward. The pivot portion 72 on the right side is connected to the pivot portion 71 on the left side at a rear end portion thereof.

An arm portion 73 that extends rearward is formed on the rear end portion of the pivot portion 72 on the right side. The arm portion 73 extends rearward in a bending manner such that the arm portion 73 is rounded around the outside (left side) in the vehicle width direction. The rear wheel 16 is supported on a rear end portion of the arm portion 73 by way of the real wheel shaft 16a. The swing arm 17 supports the rear wheel 16 in a cantilever manner.

A link connecting portion 74 that protrudes downward is formed at a connecting portion between the pivot portion 71 on the left side and the pivot portion 72 on the right side. The link mechanism 27 is connected to the link connecting portion 74. With such a configuration, the rear cushion 28 is connected to the swing arm 17 by way of the link mechanism 27.

As illustrated in FIG. 1 to FIG. 5, the rear cushion 28 has a cylindrical shape extending in the vertical direction in an external appearance. The rear cushion 28 is connected to the pivot frame 24 above the pivot shaft 26. The rear cushion 28 is disposed between the left and right pivot portions 71, 72 of the swing arm 17 (see FIG. 5). The rear cushion 28 extends from an upper side to a lower side of the swing arm 17. Connecting portions 28a, 28b (see FIG. 6) are formed on upper and lower portions of the rear cushion 28. A hole that extends in the vehicle width direction is formed in the connecting portions 28a, 28b respectively. The connecting portion 28a of the rear cushion 28 on an upper side is swingably supported on the cushion connecting portion 61b (see FIG. 8) by a shaft extending in the vehicle width direction in a state where the connecting portion 28a is inserted into the cushion insertion portion 61c (see FIG. 9) of the pivot frame 24. The connecting portion 28b of the rear cushion 28 on a lower side is swingably supported on the link mechanism 27.

As illustrated in FIG. 5 and FIG. 6, the link mechanism 27 includes: a cushion connecting portion 76 having an approximately triangular shape as viewed in a side view of the vehicle; and a pair of left and right links 77, 78 that is rotatably supported by the cushion connecting portion 76.

Swingable portions 76a, 76b are formed on the cushion connecting portion 76 at positions corresponding to vertices of an approximately triangular shape. More specifically, the cushion connecting portion 76 includes: the swingable portion 76a on a rear upper side; the swingable portion 76b on a front lower side disposed in front of and below the swingable portion 76a; and the swingable portion 76c on a rear lower side disposed behind the swingable portion 76b on the front lower side.

The swingable portion 76a on the rear upper side is swingably connected to the link connecting portion 74 on the swing arm 17. The connecting portion 28b of the rear cushion 28 on the lower side is swingably connected to the swingable portion 76b on the front lower side. The pair of left and right links 77, 78 is swingably connected to the swingable portion 76c on the rear lower side. The links 77, 78 extend frontward. The links 77, 78 are respectively arranged on both left and right sides of the link connecting portion 68 that forms a lower end portion of the pivot frame 24. The links 77, 78 are swingably connected to the link connecting portion 68 of the pivot frame 24.

That is, on the pivot frame 24, the connecting portion 28a that forms an upper end of the rear cushion 28 is supported and at the same time, the connecting portion 28b that forms a lower end of the rear cushion 28 is supported by way of the link mechanism 27. With such a configuration, the upper and lower ends of the rear cushion 28 that is mounted on the swing arm 17 are supported on one member that is referred to as the pivot frame 24. Accordingly, such a configuration can easily contribute to making the rear cushion 28 compact and to the accuracy management of the rear cushion 28.

The rear cushion 28 is extended or retracted by way of the link mechanism 27 and hence, swinging of the swing arm 17 is attenuated.

FIG. 11 is a cross-sectional view taken along a line XI-XI in FIG. 6.

In the present embodiment, a pair of left and right pivot sub frames 80, 81 is respectively disposed both outsides the swing arm 17 in the vehicle width direction. The pivot sub frames 80, 81 are disposed outsides the pivot portions 71, 72 of the swing arm in the vehicle width direction. The pivot sub frames 80, 81 extend in the vertical direction. The pivot sub frames 80, 81 are bent toward the inside in the vehicle width direction as the pivot sub frames 80, 81 advance downward. Upper end portions of the pivot sub frames 80, 81 are supported on an end portion of the pivot shaft 26 (see FIG. 1, FIG. 2). Lower end portions of the pivot sub frames 80, 81 are fixed to the plate fixing portion 69 of the pivot frame 24. Predetermined spaces S2, S3 are formed between the pivot sub frames 80, 81 and the pivot frame 24.

A side stand 82 is rotatably supported on the pivot sub frame 80 on the left side. When the side stand 82 is installed on a road surface R in an upright state, it is possible support the vehicle body in an inclined state toward the side of the side stand 82.

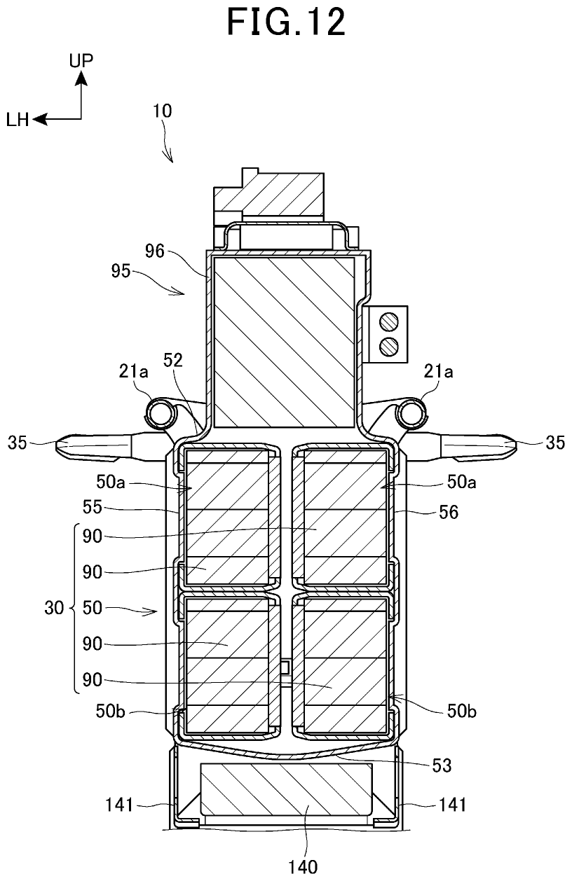

FIG. 12 is a cross-sectional view taken along a line XII-XII in FIG. 6. FIG. 12 illustrates a cross section of the battery 30.

The battery 30 includes a battery case 50, and a plurality of battery units (battery bodies) 90 that are housed in the battery case 50.

In the inside of the battery case 50, battery housing portions 50a, 50b are formed in two stages, that is, in upper and lower stages. The battery housing portions 50a, 50b that are formed in two stages, that is, in upper and lower stages are respectively formed in pairs at left and right sides. Accordingly, in the inside of the battery case 50, four battery housing portions 50a, 50b are formed in total. The basic configuration of the battery housing portion 50a and the basic configuration of the battery housing portion 50b are substantially equal irrelevant to their positions. In the battery housing portions 50a, 50b, the battery units 90 that have substantially the same configuration are respectively housed in the battery housing portions 50a, 50b. The battery unit 90 has an elongated rectangular parallelepiped shape. The battery unit 90 is a portion that stores electricity, and is a main body portion of the battery 30 according to the present embodiment.

The battery housing portions 50a on the upper side are formed in front of the battery housing portions 50b on the lower side. That is, the battery housing portions 50a on the upper side are formed offset toward a front side than battery housing portions 50b on the lower side. In other words, as illustrated in FIG. 1 and FIG. 2, at the rear surface portion 54 of the battery case 50, the battery housing portion 50a on an upper side is formed by a space extending frontward from a front side rear surface 54a. Further, the battery housing portion 50b on a lower side is formed by a space extending frontward from a rear side rear surface 54c. With such a configuration, in the battery case 50, the upper and lower battery units 90 are arranged in a vertically overlapping manner in a state where the upper and lower battery units 90 are offset in the longitudinal direction.

In FIG. 12, side surface portions 55, 56 of the battery case 50 are positioned inside upper frames 21a, 21a in the vehicle width direction. That is, the side surface portions 55, 56 of the battery case 50 are positioned inside outer ends of upper frames 21a, 21a in the vehicle width direction, and are substantially positioned inside inner ends of the upper frames 21a in the vehicle width direction. With such a configuration, a bulging shape of the battery case 50 in the vehicle width direction can be suppressed.

In the battery 30, heat of the battery units 90 is radiated via the battery case 50. A traveling air impinges on the battery case 50 and cools the battery case 50. With such a configuration, in this embodiment, a radiator 130 is disposed below the bottom surface portion 53 of the battery case 50 and hence, the battery case 50 is positioned where the battery case 50 is minimally affected by discharge air from the radiator 130 and the like. Accordingly, the battery case 50 is easily cooled by traveling air. Although the case is illustrated where the battery case 50 has a flat planar surface shape, cooling fins may be formed on the battery case 50. For example, the configuration may be adopted where cooling fins may be formed on the side surface portions 55, 56 thus cooling the battery case 50 by travelling air outside the battery case 50.

A junction box (a power distribution box) 95 is disposed above the battery case 50. The junction box 95 includes: a body portion in which various electronic component parts not illustrated in the drawing such as a contactor, a main fuse, a current sensor are mounted; and an exterior case 96 that covers the body portion. Predetermined wirings that extend from an electric harness 97 (see FIG. 6) are connected to the junction box 95. The junction box 95 is formed in an approximately rectangular shape. The junction box 95 is shorter than one battery unit 90 in the longitudinal direction, and is larger than one battery unit 90 in the lateral direction. The junction box 95 is smaller than two battery units 90 arranged laterally. That is, the junction box 95 is shorter than the battery case 50 in the longitudinal direction. Further, the lateral width of the junction box 95 is narrower than the lateral width of the battery case 50. The junction box 95 extends upward between the pair of upper frames 21a. In the embodiment, the exterior case 96 is integrally formed with the battery case 50, and extends upward from the ceiling surface portion 52.

As illustrated in FIG. 6, the PCU 31 is disposed behind the junction box 95 and above the battery case 50. The PCU 31 includes a PCU case 100. The PCU case 100 has a rectangular parallelepiped shape. The PCU case 100 has a rectangular parallelepiped shape extending along the ceiling surface portion 52 of the battery 30. The electric motor 12 is disposed behind the PCU case 100.

The electric motor 12 is disposed behind the PCU 31. The electric motor 12 is disposed above the pivot frame 24 and just above the pivot shaft 26.

As illustrated in FIG. 11, the electric motor 12 includes a cylindrical motor case 110. A motor shaft 111 that extends in the vehicle width direction is rotatably supported by the motor case 110. A rotor 112 is fixed to the motor shaft 111. A stator 113 having a coil portion is supported outside the rotor 112 in a radial direction. The motor shaft 111 protrudes toward a right side of the motor case 110. A drive gear 114 is supported on a distal end of the motor shaft 111 on a right side. The drive gear 114 is connected to an input gear 121 of the speed reduction gear 32.

The motor case 110 is fixed to the PCU case 100 by a fixing jig from behind, and the PCU 31 and the electric motor 12 are integrally formed with each other (see FIG. 1, FIG. 2 and FIG. 6). A fixing lug 110a that is fixed to the pivot frame 24 is mounted on an outer peripheral portion of the motor case 110 of the electric motor 12. The fixing lug 110a is fastened to fastening portions 66a, 66b of the pivot frame 24 (see FIG. 9) and the like.

A lateral width of the electric motor 12 is formed larger than a lateral width of the pivot frame 24. More specifically, the lateral width of the electric motor 12 is formed larger than the lateral width from a right end of the pivot shaft support portion 62 to a left end of the output shaft support portion 63. With such a configuration, a space S4 is formed below the electric motor 12 and on a right side of the pivot frame 24. The speed reduction gear 32 is disposed in the space S4. The speed reduction gear 32 is disposed in a state where the speed reduction gear 32 advances to the stepped surface 54b of the battery case 50 (see FIG. 2). As viewed in a side view of the vehicle body, the speed reduction gear 32 extends rearward and upward, and is disposed on a side (a right side) of the electric motor 12.

Conventionally, for example, a vehicle width of an electric two-wheeled vehicle depends on a size of stacking of four layers consisting of an electric motor, a speed reduction gear, and left and right pivot frames. On the other hand, with such a configuration, in this embodiment, the pivot frame 24 is smaller than the lateral width of the electric motor 12, the vehicle width of the electric two-wheeled vehicle 10 is made to fall within stacking of two layers consisting of the electric motor 12 and the speed reduction gear 32 and hence, the lateral width (vehicle width) of the electric two-wheeled vehicle 10 can be easily made small.

The speed reduction gear 32 includes a speed reduction gear case (case) 120, the input gear 121, an output gear (not illustrated in the drawing), and an intermediate gear disposed between the input gear 121 and the output gear.

In this embodiment, the speed reduction gear case 120 has the two-split (left and right halves) structure. The speed reduction gear case 120 is assembled by combining the left and right halves in an overlapping manner in the lateral direction. In the inside of the speed reduction gear case 120, the input gear 121, the output gear and the like are rotatably disposed. With such a configuration, the rotation of the input gear 121 can be outputted from the output gear at a desired speed reduction ratio.

The speed reduction gear case 120 is fastened to the motor case 110 of the electric motor 12, the fastening plate 64 (see FIG. 8) of the pivot frame 24 and the like from the outside in the vehicle width direction.

In FIG. 11, a line L12 that passes a connecting plane between the motor case 110 of the electric motor 12 and the speed reduction gear case 120 of the speed reduction gear 32 and a line L11 that passes a side surface of the fastening plate 64 of the pivot frame 24 are spaced apart from each other in the vehicle width direction. The speed reduction gear case 120 includes a protruding portion 120a that protrudes toward the fastening plate 64 of the pivot frame 24. With the provision of the protruding portion 120a, the space S4 formed between electric motor 12 and the pivot frame 24 can be used as an arrangement space for the speed reduction gear 32.

An output gear is disposed in the protruding portion 120a of the speed reduction gear case 120. An output shaft 122 that extends in the vehicle width direction is fixed to the output gear. The output shaft 122 is made to pass through an output shaft support portion 63 (see FIG. 8) formed in the pivot frame 24. The output shaft 122 extends to both sides of the pivot frame 24 in the vehicle width direction.

A drive pulley 125 is disposed on the output shaft 122 on a side opposite to the speed reduction gear 32 in the vehicle width direction (see FIG. 1). The drive pulley 125 is integrally rotated with the output shaft 122. A drive belt (belt) 126 having an endless strip shape is wound around the drive pulley 125. The drive belt 126 extends rearward, and is wound around a driven pulley 127 fixed to the rear wheel shaft 12a. The drive belt 126 is positioned above and below the pivot portion 71 of the swing arm 17 on a left side as viewed in a side view of the vehicle body.

The power transmission mechanism 33 according to the present embodiment is formed of the drive pulley 125, the drive belt 126 and the driven pulley 127.

In the present embodiment, the pivot shaft 26 and the output shaft 122 are supported by the pivot frame 24 and hence, it is possible to easily ensure accuracy in mounting the pivot shaft 26 and the output shaft 122. Accordingly, an accuracy control in assembling a drive system relating to the output shaft 122 and a swing system relating to the pivot shaft 26 can be easily performed.

In the above-mentioned configuration, as viewed in a side view of the vehicle, the output shaft support portion 63 is positioned above the line L3 that connects the pivot shaft 26 and the rear wheel shaft 16a. With such a configuration, with respect to the drive belt 126 wound around the drive pulley 125, sinking of the drive belt 126 and a change in a circumferential length of the drive belt 126 in the extending direction can be made substantially equal and hence, even with the use of the power transmission mechanism 33 that uses the drive belt 126, the pivot shaft 26 and the output shaft 122 are provided as separate shafts and hence, accuracy in tension can be easily acquired.

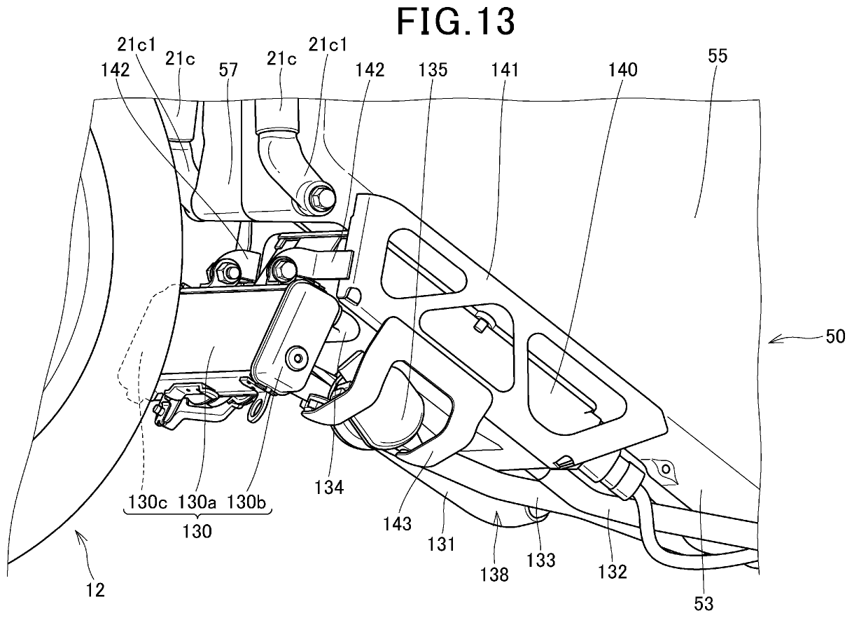

FIG. 13 is a perspective view illustrating the surrounding of a lower portion of the battery case 50 as viewed from a front left side.

Below the battery case 50, a radiator 130 that cools electric vehicle functional parts. More specifically, the radiator 130 is disposed below an onboard charger 140 that is supported below the battery case 50. As electric vehicle functional parts, in the present embodiment, the electric motor 12, the PCU 31, and the onboard charger (charger) 140 are named. That is, in the present embodiment, the bottom surface portion 53 is obliquely disposed and hence, the space S1 is formed below the battery 30, and the radiator 130 can be disposed in the space S1. Further, the space S1 is sufficiently large and hence, the onboard charger 140 may be disposed in the space S1. However, by disposing the onboard charger 140 such that the onboard charger 140 is supported on the bottom surface bracket 141, the onboard charger 140 can be laid out in a compact manner.

Particularly, in the present embodiment, a lowermost portion 130d (see FIG. 1) of the radiator 130 is positioned below a line L3 that connects a front wheel axis 13a and a rear wheel axis 16a as viewed in a side view of the vehicle. The radiator 130 can be disposed in a dead space formed below the vehicle.

Here, the radiator 130 is disposed above an extension L4 of the down frame 21c as viewed in a side view of the vehicle. With such a configuration, the radiator 130 can be disposed at a position on a front side of the vehicle where the radiator 130 easily receive travelilng air. Further, the arrangement of the radiator 130 can be laid out following the shape of the frame. Still further, as viewed in a side view of the vehicle, the radiator 130 is positioned above a rear end of the bottom surface portion 53 of the battery 30, and below a front end of the bottom surface portion 53 of the battery 30, and is disposed behind the front wheel 13. That is, assuming a horizontal line that passes a rear end of the bottom surface portion 53 of the battery 30 as a rear end line L5 and a horizontal line that passes a front end of the bottom surface portion 53 of the battery 30 as a front end line L6, as viewed in a side view of the vehicle, the radiator 130 is disposed above the rear end line L5 and below the front end line L6, and is disposed behind the front wheel 13. By disposing the radiator 130 behind the front wheel 13 where the width of the radiator 130 in the vehicle width direction is liable to become narrow, the radiator 130 can easily receive traveling air.

To describe the specific arrangement structure of the radiator 130, a pair of left and right bottom surface brackets (brackets) 141 is fixed to the bottom surface portion 53. The bottom surface brackets 141 extend in the longitudinal direction. In each bottom surface bracket 141, a plurality of wall thinning holes having a triangular shape that penetrate in the lateral direction are formed. The onboard charger 140 having a rectangular parallelepiped shape is disposed between the left and right bottom surface brackets 141. The onboard charger 140 is supported on the left and right bottom surface brackets 141. The onboard charger 140 is inclined forward and downward along the bottom surface portion 53. The onboard charger 140 is electrically connected to the battery 30. The onboard charger 140 converts an alternating current power to a direct current power, and supplies the direct current power to the battery unit 90.

On a front end of the bottom surface bracket 141, a bracket stay (bracket) 142 that extends frontward and downward are mounted. The radiator 130 is fastened to the bracket stay 142. The radiator 130 is supported by the bottom surface bracket 141 and the bracket stay 142 in a suspended manner on a front side below the bottom surface portion 53. The radiator 130 is disposed in the space S1 (see FIG. 1) having an approximately triangular shape surrounded by the front wheel 13, the bottom surface portion 53 of the battery case 50 and a road surface R. The radiator 130 is supported by the bottom surface bracket 141 and the bracket stay 142 and hence, even below the vehicle, the radiator 130 can be supported in a compact manner.

The radiator 130 includes: a core 130a having a plate shape in external appearance and extending in the vehicle width direction; a tank 130b disposed on a left side of the core 130a; and a tank 130c disposed on a right side of the core 130a. With respect to the core 130a into which traveling air flows, a lower portion of the core 130a is disposed in front of an upper portion of the core 130a. That is, the core 130a is inclined upward as a front surface thereof advances rearward. The core 130a faces the front wheel 13 below the front wheel axis 13a. With respect to the front surface of the core 130a, a lower portion is positioned in front of an upper portion, the radiator 130 can receive traveling air while preventing sands or the like adhering to the front wheel 13 from advancing toward the front surface of the radiator 130.

As illustrated in FIG. 5, to the tank 130c disposed on the right side of the radiator 130, a first cooling pipe 131 that extends rearward is connected. A downstream end of the firs cooling pipe 131 is connected to the onboard charger 140. A cooling path not illustrated in the drawing is formed on the onboard charger 140. A second cooling pipe 132 that extends rearward is connected to a discharge port that forms a downstream end of the cooling path of the onboard charger 140.

The second cooling pipe 132 that extends rearward, then, advances into the space S2 (see FIG. 11) formed between the pivot frame 24 and the pivot sub frame 81, and is routed toward a position above the battery case 50. The second cooling pipe 132 is routed to the position above the battery case 50 while being bent in a stepped manner along the rear surface portion 54 (see FIG. 1), a downstream end of the second cooling pipe 132 is connected to the PCU case 100. In the inside of the PCU case 100, a cooling path that communicates with the inside of the motor case 110 of the electric motor 12 is formed. As illustrated in FIG. 2, on a rear surface of the motor case 110 of the electric motor 12, a discharge port that forms a downstream end of the cooling path is formed, and a third cooling pipe 133 is connected to the discharge port.

The third cooling pipe 133 is routed on a right side of the pivot frame 24 and the swing arm 17 and are routed downward. The third cooling pipe 133 that routed downward passes through the space S3 (see FIG. 11) between the pivot frame 24 and the pivot sub frame 80, and is routed on a front side downward the bottom surface portion 53. As illustrated in FIG. 5, a front end portion of the third cooling pipe 133 is bent toward a left side, and is connected to an inflow portion 135a of a water pump 135 extending in an axial direction. The water pump 135 is fixed to the bottom surface bracket 141 on a left side by way of a pump bracket 143. The water pump 135 is driven by an electric motor (not illustrated in the drawing) that differs from the electric motor 12 for driving. The water pump 135 supply cooling water under pressure to the outside from a discharge portion 135b of the water pump 135 in a radial direction. A fourth cooling pipe 134 is connected to the discharge portion 135b of the water pump 135. A downstream end of the fourth cooling pipe 134 is connected to a tank 130b disposed on a left side of the radiator 130.

In this embodiment, a circulation path 138 through which cooling water circulates is constituted of the radiator 130, the onboard charger (electric vehicle functional part) 140, the PCU (electric vehicle functional part) 31, the electric motor (electric vehicle functional part) 12, the water pump 135, and the cooling pipes 131 to 134 that suitably connect these parts. In the circulation path 138, by driving the water pump 135, cooling water circulate in order of the onboard charger 140, the PCU 31, and the electric motor 12 so as to cool these parts. In such a configuration, a heat value is increased in an ascending order of onboard charger 140, the PCU 31 and the electric motor 12. Accordingly, by allowing cooling water to pass through the onboard charger 140, the PCU 31 and the electric motor 12 in this order, even when a temperature of cooling water rises, such cooling water is allowed to flow toward a downstream side at a high temperature and hence, these parts can be efficiently cooled.

Particularly, the onboard charger 140 that is cooled first is disposed on the bottom surface portion 53 together with the radiator 130, and the onboard charger 140 is disposed near the radiator 130. With such a configuration, cooling water that is cooled by the radiator 130 can be speedily supplied to the onboard charger 140. Accordingly, compared to a case where the radiator 130 and the respective electric vehicle functional parts are disposed in a spaced-apart manner from each other, the compact circulation path 138 can be easily routed.

On a back surface of the radiator 130, a radiator fan (air cooling fan) 136 having a circular shape is disposed. The radiator fan 136 is disposed on a right side in the vehicle width direction, and is disposed close to the tank 130c side on a right side. The radiator fan 136 generates a negative pressure between the radiator fan 136 and the radiator 130, and introduces cooling air into the radiator 130 from a front side of the radiator 130. The cooling air that cools cooling water by the radiator 130 is discharged rearward by the radiator fan 136. The radiator fan 136 and the water pump 135 are disposed behind the radiator 130 and between the radiator 130 and the battery 30. With such a configuration, the radiator fan 136 and the water pump 135 can be disposed in the space S1 formed below the battery 30 in a compact manner. Particularly, the radiator fan 136 is disposed close to the tank 130c on a right side, and is disposed at a position away from the water pump 135. With such a configuration, the radiator fan 136 and the water pump 135 can be efficiently disposed thus facilitating the compact arrangement of these parts.

As illustrated in FIG. 6, above the junction box 95, a front electricity supply unit 98 is disposed. The front electricity supply unit 98 includes an upper surface electricity supply port 99 that is connected to an external power supply. The upper surface electricity supply port 99 is formed in accordance with a predetermined regulation. The upper surface electricity supply port 99 includes a terminal for alternating current charging and a terminal for direct current charging. The upper surface electricity supply port 99 is directed upward. The upper surface electricity supply port 99 is electrically connected to the onboard charger 140 and the battery 30.

Around the front electricity supply unit 98, an alternating current charging cable 150 is provided in a storable manner. In this embodiment, the alternating current charging cable 150 is storable in the electric two-wheeled vehicle 10 in a state where the alternating current charging cable 150 is wrapped around the front electricity supply unit 98. The stored alternating current charging cable 150 is covered by a unit cowl 41 that is detachably formed (see FIG. 1).

In the present embodiment, the alternating current charging cable 150 includes: an electricity supply gun portion 151 that is connected to the upper surface electricity supply port 99; a power cable portion 152 extending from the electricity supply gun portion 151; and a plug portion 153 connected to the other end of the power cable portion 152. With respect to the alternating current charging cable 150, the electricity supply gun portion 151 is connected to the upper surface electricity supply port 99 from above, and the plug portion 153 is connected to a so-called family-use socket. With such a configuration, alternating current power is supplied to the upper surface electricity supply port 99, and electricity is charged to the battery 30 via the onboard charger 140.

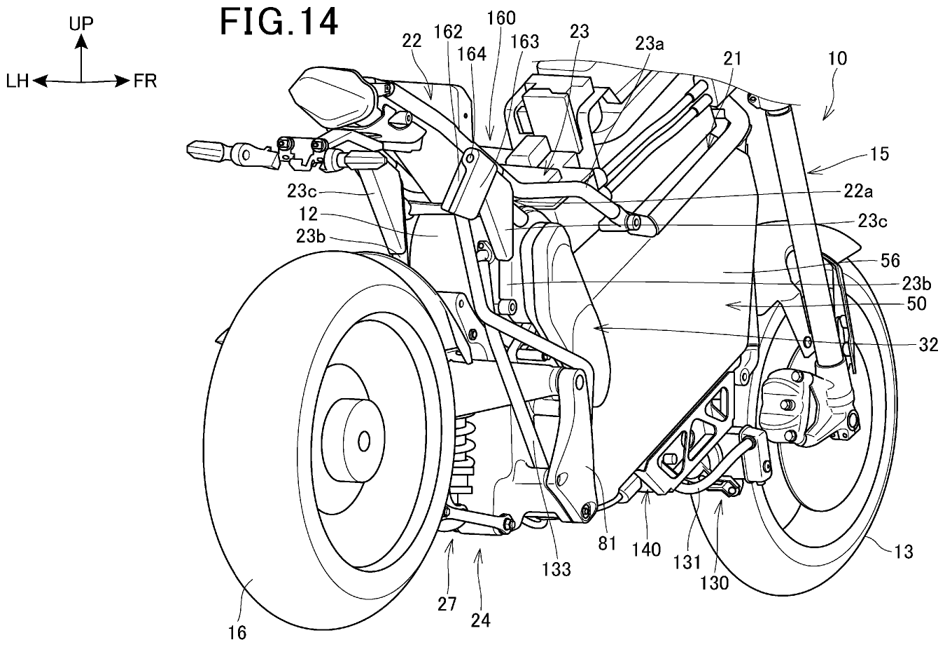

FIG. 14 is a perspective view illustrating a main part of the electric two-wheeled vehicle 10 as viewed from a right rear side in a state where the vehicle body cover 40 is not illustrated in the drawing.

A side electricity supply unit 160 is supported on the rear frame 22. The side electricity supply unit 160 is disposed on a right side surface of the vehicle on a side opposite to the side stand 82. The side electricity supply unit 160 includes: a side electricity supply port (electricity supply port) 161 (see FIG. 2) that is connected to an external power source; a base cover 162 that embraces the side electricity supply port 161; an open-close cover 163 that is supported on the base cover 162 in an openable and closable manner about a hinge 164. The side electricity supply port 161 is formed based on a predetermined regulation. The side electricity supply port 161 includes a terminal for alternating current charging and a terminal for direct current charging. The side electricity supply port 161 is electrically connected to the onboard charger 140 and the battery 30. With respect to the side electricity supply unit 160, a normal direction N1 orthogonal to a connecting surface of the side electricity supply port 161, that is, an inserting direction toward the side electricity supply port 161 intersects with an extending direction L20 of the side stand 82 as viewed in a plan view (see FIG. 4). The side electricity supply unit 160 is disposed in front of a grab rail 23d.

Electricity can be supplied from the side of vehicle body by the side electricity supply unit 160. Accordingly, for example, in a case where the electric two-wheeled vehicle 10 is stopped on a side of a charging facility of a high-speed electricity station or the like, an external power supply provided to the charging facility can be connected to the side electricity supply unit 160 from the side. In such an operation, a user can connect the external power supply to the side electricity supply port 161 or remove the external power supply from the side electricity supply port 161 in a state where the electric two-wheeled vehicle 10 is brought into a stable state by grabbing the grab rail 23d.

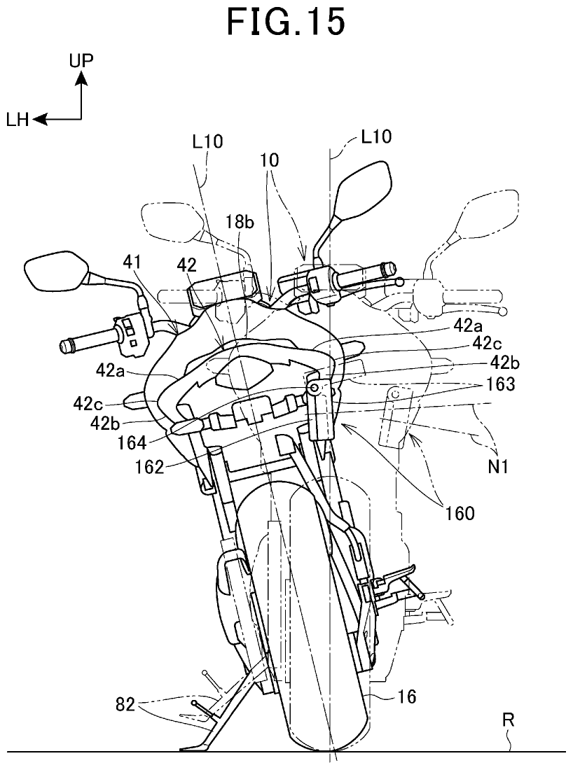

FIG. 15 is a rear view of the electric two-wheeled vehicle 10 when the side stand 82 is used. In FIG. 15, a two-dot chain line indicates the electric two-wheeled vehicle 10 in an upright state. That is, the two-dot chain line indicates the state where the side stand 82 is not used. In this case, the vehicle width center line L10 is vertical to the road surface R. A solid line indicates a stopped state where the electric two-wheeled vehicle 10 uses the side stand 82. In this case, the vehicle width center line L10 is also inclined.

In the present embodiment, the side electricity supply unit 160 is disposed below a ridge line 42c of the rear cowl 42. Further, an outer surface of the side electricity supply unit 160 in the vehicle width direction is disposed along a lower surface 42b of the rear cowl 42. With such a configuration, the side electricity supply unit 160 can be disposed while suppressing a protruding shape thereof in the vehicle width direction. The lower surface 42b of the rear cowl 42 is directed downward and hence, it is possible to provide the side electricity supply port 161 at a position that is minimally apparent in external appearance.

The side electricity supply unit 160 is disposed at a connecting portion 22a where the seat rail 23a and the seat sub frame 23b are connected to each other. The connecting portion 22a is used in the context that an area near the position at which the extending direction of the seat rail 23a and the extending direction of the seat sub frame 23b intersect with each other. In other words, the connecting portion 22a may be also referred to as a portion that is supported by both of the seat rail 23a and the seat sub frame 23b. Accordingly, for example, the position that overlaps with the rear gusset 23c as viewed in a side view of the vehicle is the connecting portion 22a. In the present embodiment, the side electricity supply unit 160 is disposed such that the side electricity supply unit 160 overlaps with the rear gusset 23c as viewed in a side view of the vehicle body.

The side electricity supply unit 160 is disposed such that the normal direction N1 of the side electricity supply unit 160 is directed rightward and downward. That is, with respect to the electric two-wheeled vehicle 10 disposed in an upright state, the side electricity supply unit 160 is disposed such that the normal direction N1 is the direction that is spaced apart from the side stand 82 and is directed slightly downward as viewed in a rear view. In other words, the electric two-wheeled vehicle 10 in an upright state is disposed such that, when the vehicle body of the electric two-wheeled vehicle 10 is inclined by using the side stand 82, the normal direction N1 of the side electricity supply port 161 becomes at least perpendicular to the road surface R. That is, the normal direction N1 is rotated at an angle perpendicular to the road surface R or more so that the direction of the side electricity supply port 161 becomes an angle perpendicular to the road surface R or an angle of elevation with respect to the road surface R.

Accordingly, the side electricity supply unit 160 is disposed on the connecting portion 22a between seat rail 23a and the seat sub frame 23b and hence, the side electricity supply unit 160 is disposed at the position having rigidity referred to as the connecting portion 22a whereby an external power supply can be easily connected to the side electricity supply port 161. Particularly, the side electricity supply unit 160 according to the present embodiment is disposed on a side opposite to the side stand 82 and hence, the side stand 82 can easily receive a force generated in the connecting direction of the external power supply at the time of charging electricity. Further, the normal direction N1 of the side electricity supply port 161 is directed downward and hence, when the vehicle body takes an inclined posture, the side electricity supply port 161 is exposed to the side surface whereby an operator can easily get access to the side electricity supply port 161.

As has been described above, according to the present embodiment to which the present invention is applied, in the electric two-wheeled vehicle 10 that includes: the vehicle body frame 11 having the pivot frame 24 that supports the swing arm 17 swingably; the electric motor 12 disposed above the pivot shaft 26: and the speed reduction gear 32 disposed on the side of the electric motor 12, the lateral width of the pivot frame 24 is narrower than the lateral width of the electric motor 12, and the speed reduction gear 32 is disposed on the side of the pivot frame 24.

With such a configuration, the lateral width of the pivot frame 24 is affected by neither the electric motor 12 nor the speed reduction gear 32 and hence, it is possible to take a desired measure such as narrowing of the width of the pivot frame 24. Further, the space S4 may be easily formed on the side of the pivot frame 24 and the speed reduction gear 24 can be disposed by making use of this space S4. Accordingly, in the electric two-wheeled vehicle 10 provided with the speed reduction gear 32 on the side of the electric motor 12, it is possible to make the layout around the pivot shaft 26 compact.

In this embodiment, the swing arm 17 has the pair of left and right pivot portions 71, 72 that is pivotally supported on the pivot shaft 26, and the pivot frame 24 is a single member disposed between the pair of left and right pivot portions 71, 72.

With such a configuration, even when the pivot frame 24 is narrow, the rigidity and a strength of the pivot frame 24 can be easily ensured and hence, it is possible to provide the compact pivot frame 24.

Further, in the present embodiment, as illustrated in FIG. 11, the line L12 that passes the connecting plane between the electric motor 12 and the speed reduction gear 32 and the line L11 that passes the side surface of the pivot frame 24 are spaced apart from each other. Accordingly, the connecting plane between the electric motor 12 and the speed reduction gear 32 and the side surface of the pivot frame 24 are spaced apart from each other, and the speed reduction gear case 120 of the speed reduction gear 32 has the protruding portion 120a that protrudes toward the pivot frame 24 side.

With such a configuration, the space S4 formed between the electric motor 12 and the pivot frame 24 can be used as the space for disposing the speed reduction gear 32.

In the present embodiment, the pivot frame 24 has the output shaft support portion 63, the output shaft support portion 63 includes an output shaft hole 63a that penetrates the pivot frame 24 laterally. The output shaft 122 is made to pass through the output shaft support portion 63. The drive pulley 125 is disposed on the output shaft 122 on the side opposite to the speed reduction gear 32.

With such a configuration, the pivot shaft 26 and the output shaft 122 are supported on the pivot frame 24 and hence, accuracy in mounting the pivot shaft 26 and the output shaft 122 can be easily ensured, and the control of accuracy in assembling the swing system relating to the pivot shaft 26 and the drive system relating to the output shaft 122 can be easily ensured. Even in the case where the rear wheel 16 is driven by using the drive belt 126, accuracy in mounting the pivot shaft 26 and the output shaft 122 can be easily ensured and hence, accuracy in tension of the drive belt 126 can be easily ensured although these shafts are not formed of the same shaft but are different shafts.

Further, in the present embodiment, the output shaft support portion 63 is positioned on the line L2 that connects the pivot shaft 26 and the rear wheel shaft 16a to each other as viewed in a side view of the vehicle.

With such a configuration, with respect to the drive belt 126 that is wound around the drive pulley 125, sinking and a change in the circumferential length in the extending direction can be set substantially equal and hence, the configuration is suitable in the case where the driving using the belt is adopted.

Further, in the present embodiment, the pivot frame 24 includes: the front arm portion 65 that extends frontward along the outer periphery of the electric motor 12; and the rear arm portion 61 that extends rearward along the outer periphery of the electric motor 12, and pivot frame 24 supports the electric motor 12 and the rear frame 22 that supports the seat 18 by the front arm portion 65 and the rear arm portion 61.

Such a configuration contributes to the enhancement of the rigidity of the pivot frame 24 having the width narrower than the lateral width of the electric motor 12, and enables the connection between the pivot frame 24 with other members.

Further, in the present embodiment, the pivot frame 24 supports the lower end and the upper end of the rear cushion 28.

With such a configuration, the rear cushion 28 that is mounted on the swing arm 17 can be supported on the pivot frame 24 and hence, the configuration contributes to make the rear cushion 28 compact and to the control of accuracy of the rear cushion.

### Other Embodiments

The above-mentioned embodiment exemplifies only one mode of the present invention and modifications and variations of the present invention can be made as desired without departing from the gist of the present invention.

In the above-mentioned embodiment, the description has been made by taking the electric two-wheeled vehicle 10 having the front wheel 13 and the rear wheel 16 as the electric vehicle as an example. However, the present invention is not limited to such an electric two-wheeled vehicle. The present invention is applicable to a three-wheeled vehicle having two front wheels or rear wheels or an electric saddle-riding vehicle that includes four or more wheels.

### Configurations that are Supported by the Above-Mentioned Embodiment

The above-mentioned embodiment supports the following configurations.

### Configuration 1

An electric vehicle includes: a vehicle body frame having a pivot frame that supports a swing arm swingably; a motor disposed above a pivot shaft; and a speed reduction gear disposed on a side of the motor. In the electric vehicle, a lateral width of the pivot frame is narrower than a lateral width of the motor, and the speed reduction gear is disposed on a side of the pivot frame.

With such a configuration, the lateral width of the pivot frame is affected by neither the motor nor the speed reduction gear and hence, it is possible to take a desired measure such as narrowing of the width of the pivot frame. Further, the space may be formed on the side of the pivot frame and the speed reduction gear can be disposed by making use of this space. Accordingly, in the electric vehicle provided with the speed reduction gear on the side of the motor, it is possible to make the layout around the pivot shaft compact.

### Configuration 2

In the electric vehicle according to the configuration 1, the swing arm has a pair of left and right pivot portions that is swingably supported on the pivot shaft, and the pivot frame is a single member disposed between the pair of left and right pivot portions.

With such a configuration, even when the width of the pivot frame is narrow, the rigidity and a strength of the pivot frame can be easily ensured and hence, it is possible to provide the compact pivot frame.

### Configuration 3

In the electric vehicle according to the configuration 1 or 2, a line that passes a connecting plane between the motor and the speed reduction gear and a side surface of the pivot frame are spaced apart from each other, and a case of the speed reduction gear has a protruding portion that protrudes toward a side of the pivot frame.

With such a configuration, the space formed between the motor and the pivot frame can be used as the space for disposing the speed reduction gear.

### Configuration 4

In the electric vehicle according to any of the configuration 1 to 3, the pivot frame has an output shaft support portion, the output shaft support portion is a hole that penetrates laterally, and an output shaft is made to pass through the output shaft support portion, and a drive pulley is disposed on the output shaft on a side opposite to the speed reduction gear.

With such a configuration, the pivot shaft and the output shaft are supported on the pivot frame and hence, accuracy in mounting the pivot shaft and the output shaft can be easily ensured, and the control of accuracy in assembling the swing system relating to the pivot shaft and the drive system relating to the output shaft can be easily ensured.

### Configuration 5

In the electric vehicle according to the configuration 4, the output shaft support portion is positioned on a line that connects the pivot shaft and a rear wheel shaft to each other as viewed in a side view of a vehicle.

With such a configuration, with respect to the belt that is wound around the drive pulley, sinking and a change in the circumferential length in the extending direction can be set substantially equal and hence, the configuration is suitable in the case where the driving using the belt is adopted.

### Configuration 6

In the electric vehicle according to any of the configurations 1 to 5, the pivot frame includes: a first arm that extends frontward along an outer periphery of the motor; and a second arm that extends rearward along the outer periphery of the motor, and the pivot frame supports the motor and a rear frame that supports a seat by the first arm and the second arm. Such a configuration contributes to the enhancement of the rigidity of the pivot frame having the width narrower than the lateral width of the motor, and enables the connection between the pivot frame with other members.

### Configuration 7

In the electric vehicle according to any of the configurations 1 to 6, the pivot frame supports a lower end and an upper end of a cushion.

With such a configuration, the cushion that is mounted on the swing arm can be supported on the pivot frame and hence, the configuration contributes to make the cushion compact and to the control of accuracy of the cushion.

### REFERENCE SINGS LIST

10: electric two-wheeled vehicle (electric vehicle)
11: vehicle body
12: electric motor (motor)
16a: rear wheel shaft
17: swing arm
18: seat
22: rear frame
24: pivot frame (other frame)
26: pivot shaft
28: rear cushion (cushion)
32: speed reduction gear
61: rear arm portion (second arm)
63: output shaft support portion
65: front arm portion (first arm)
71: pivot portion
72: pivot portion
120: speed reduction gear case (case)
120a: protruding portion
122: output shaft
125: drive pulley
L2: line

1. 1 An electric vehicle comprising:
a vehicle body frame having a pivot frame that supports a swing arm swingably;
a motor disposed above a pivot shaft; and
a speed reduction gear disposed on a side of the motor, wherein
a lateral width of the pivot frame is narrower than a lateral width of the motor, and
the speed reduction gear is disposed on a side of the pivot frame.

2. The electric vehicle according to claim 1, wherein
the swing arm has a pair of left and right pivot portions that is swingably supported on the pivot shaft, and
the pivot frame is a single member disposed between the pair of left and right pivot portions.

3. The electric vehicle according to claim 1, wherein
a line that passes a connecting plane between the motor and the speed reduction gear and a side surface of the pivot frame are spaced apart from each other, and
a case of the speed reduction gear has a protruding portion that protrudes toward a side of the pivot frame.

4. The electric vehicle according to claim 1, wherein
the pivot frame has an output shaft support portion,
the output shaft support portion is a hole that penetrates laterally, and
an output shaft is made to pass through the output shaft support portion, and
a drive pulley is disposed on the output shaft on a side opposite to the speed reduction gear.

5. The electric vehicle according to claim 4, wherein
the output shaft support portion is positioned on a line that connects the pivot shaft and a rear wheel shaft to each other as viewed in a side view of a vehicle.

6. The electric vehicle according to claim 1, wherein
the pivot frame includes: a first arm that extends frontward along an outer periphery of the motor; and a second arm that extends rearward along the outer periphery of the motor, and
the pivot frame supports the motor and a rear frame that supports a seat by the first arm and the second arm.

7. The electric vehicle according to claim 1, wherein
the pivot frame supports a lower end and an upper end of a cushion.
